(19) United States
(12) Patent Application Publication
(10) Pub. No.: US 2026/0118237 A1
(43) Pub. Date: Apr. 30, 2026

(54) SYSTEMS AND METHODS FOR PERFORMING RESPONSE TESTING AT LOW TEMPERATURES

(71) Applicant: Blue Origin Manufacturing, LLC, Huntsville, AL (US)

(72) Inventors: Bryan Matthew Hopkins, North Bend, WA (US); Jacob A. Fleming, Seattle, WA (US); Tyler R. D'Amato, Port Orchard, WA (US); Richard S. Winston, Tacoma, WA (US); Christopher Anderson, San Rafael, CA (US)

(21) Appl. No.: 18/930,858

(22) Filed: Oct. 29, 2024

(51) Int. Cl. G01N 3/06; G01N 3/30

(52) U.S. Cl. CPC G01N 3/068; G01N 3/30; G01N 2203/001; G01N 2203/006; G01N 2203/0228; G01N 2203/0641

(57) ABSTRACT

Systems and methods are directed toward low temperature testing of motion, vibration, or force responses of test fixtures. For cryogenic shock testing, a test object can be secured on a test apparatus, such as a test fixture of a shock table. An elongated enclosure, such as a flexible tube, can be connected between the test fixture and a laser vibrometer, positioned orthogonal to a surface normal at a test region of the test fixture to enable light emitted by the vibrometer to be reflected from the test region back to the vibrometer. A flow of purge gas can be introduced into the tube, proximate the test fixture, to direct moisture away from the test fixture. The flow can prevent condensation or ice from forming on the surface of the test fixture at the cryogenic temperature. A shock event can be simulated, and the response of the test region measured by the laser vibrometer. The impact of the shock event on the test object can then be observed.

### TECHNICAL FIELD

Developments disclosed and suggested herein relate generally to testing devices for use in low temperature operating environments, and particularly to systems and methods for optical measurements of those environments at cryogenic temperatures.

### BACKGROUND

As an increasing amount of activity is occurring in space, or otherwise away from the surface of the Earth, there is a corresponding need to test materials and components over a variety of temperatures and conditions that may be experienced at these locations. For example, during a launch event there may be actions, such as the separation of a stage or portion of a launch vehicle, or vehicle rocket engine ignition, which often result in severe shock environments. It can be desirable to test parts or components that may be impacted by such shock events, such as to determine the survivability of an impacted part or component. It can be important to test the part at the relevant temperature, as materials can behave differently at different temperatures, particularly at very hot or very cold (e.g., cryogenic) temperatures. Existing shock test measurement methods often include one or more accelerometers, which do not perform well at cold temperatures, and may experience an undesired zero shift or outright failure of the sensor. Reliable high acceleration measurement (characteristic of shock environments) at cold or cryogenic conditions is often difficult or impossible to achieve with an accelerator-based measurement.

### SUMMARY

Disclosed herein are systems and methods for performing testing of a test object under specific environmental conditions. This can include, for example, performing optical-based measurement of acceleration during a shock test (or other acceleration-inclusive test) of one or more test objects at one or more cold or cryogenic temperatures. One example system uses a laser doppler vibrometer to measure the acceleration response of a test region at these reduced temperatures without a need to contact the surface of the test object, or text fixture upon which the test object may be placed. A laser doppler vibrometer, or other optical measurement device, can be placed at a distance from the test region, such that the laser vibrometer will not be significantly impacted by the reduced temperature of the test fixture. To prevent condensation, which might result in ice crystals or water droplets in the path of emitted light interfering with the optical acceleration measurement of a laser vibrometer, a controlled environment dry gas can be positioned about the optical measurement region to help prevent moisture from coming near the test region. A source of this dry purge gas can be supplied to the controlled environment to push moisture out of the controlled environment before and/or continuously during testing. The purge gas in at least one embodiment is to be contained in a localized area around the optical measurement region. A semi-flexible enclosure can be constructed to provide such containment. An elongated tube, for example, made of a partially flexible and low temperature compatible material, may be affixed to the test fixture and project in a direction parallel to the emitted laser vibrometer light toward the source of the emitted light. The enclosure can project far enough out of the cold/cryogenically conditioned test area such that little, if any, vapor is able to enter the enclosure via the top opening. The top of the enclosure can be affixed to a laser vibrometer lens surround, or similar such location, using a material such as a flexible thin film membrane (e.g., a low density polyethylene) such that any acceleration or vibration imparted on the test fixture during testing is not passed on to the laser vibrometer. The tube can be attached to the test fixture using a tape, adhesive, epoxy, or other such connection mechanism that will maintain bond to the surface at cold temperatures and largely prevents moisture from permeating into the enclosed area. A continuous flow of dry purge gas (e.g., with −100 F dewpoint or lower) can be flowed directly into the enclosure such that a slight positive pressure is maintained at all times within the enclosure. It can be important in at least some embodiments to ensure that the dry purge gas flow does not excessively pressurize the contained area. Once the continuous flow of purge gas has been established at ambient conditions, a focus of the optical measurement system can be verified. A cooling mechanism, such as flow of liquid nitrogen, may be introduced to reduce the temperature of the test fixture prior to testing. Once the test fixture is at the target temperature (or in a target temperature range), the laser vibrometer can be re-verified to be active and in focus on the cold test region. A shock event or vibration (or similar occurrence) can then be simulated, such as by striking a portion of a shock table or activating other shock inducing mechanisms of, or associated with, the table. A shock event can produce an induced acceleration response in the test region, which may then be measured optically with the laser vibrometer through the established method of doppler shift measurement of a specific wavelength of light emitted by the laser vibrometer and reflected back by the moving test fixture. In this way, the acceleration measurement equipment may be fully removed from the cold/cryogenic conditions on the test fixture, and benefits of a highly-accurate optical measurement system maintained at room ambient temperature conditions may be realized. This results in highly accurate and highly repeatable shock acceleration measurements.

Various embodiments may include a cryogenic shock testing apparatus which includes a shock table that can be used to secure a test fixture, and to allow an acceleration (e.g., shock) event to be simulated with respect to the test fixture. A temperature controller can be used to reduce and maintain a temperature of the test fixture to a cryogenic (or other appropriate) temperature. An optical measurement device, such as a laser vibrometer, can be positioned to focus a test beam on a test region of the test fixture, as well as to detect a portion of the test beam reflected from the test region. A flexible tube can be used that can be connected to the test fixture to create a controlled environment between the laser vibrometer and the test fixture. A source of purge gas can be used that is able to provide a controlled flow of the purge gas through an inlet in the flexible tube proximate the test region. The flow of purge gas can be moderated to ensure that ambient air is displaced by the dry purge gas within the controlled volume before testing, such as by reducing the dewpoint of the gas within the tube forming the bulk of the optical pathway between the fixture and the laser vibrometer emitter. An acceleration event is able to be simulated via the shock table while the test fixture is at the cryogenic temperature. The laser vibrometer is able to detect a portion of the test beam that is transmitted through the controlled environment and reflected from the test region. Differences determined between one or more parameters of the emitted test beam and the reflected portion of the test beam can be indicative of a response of the test region to the simulated shock event. The impact of the acceleration event on a test object, connected to the test fixture, can then be determined.

Various embodiments may include a test environment having an elongated enclosure with at least one flexible portion. The flexible portion can prevent a force, applied proximate a first end of the elongated enclosure, from triggering movement at a second end of the elongated enclosure that is coupled to an optical measurement device, such as a laser vibrometer. The test environment can include at least one connection to allow the first end of the elongated enclosure to be coupled to a test fixture. The connection of the flexible portion may also provide a partial seal for the elongated enclosure proximate the test fixture. An inlet can be used to allow a flow of purge gas to be directed into the elongated enclosure, proximate the first end, to direct moisture away from the test fixture. The elongated enclosure can be formed of a material that is robust to reductions in temperature of the test fixture. A length of the elongated enclosure can be sufficient to prevent the reductions in temperature from impacting an operating temperature of the optical measurement device.

Various embodiments allow for a method of testing a response of a test fixture. In such a process, a first end of an elongated enclosure can be connected to a test fixture, and a second end connected to a laser vibrometer. A flow of purge gas can be directed into the elongated enclosure, proximate the test fixture, to cause moisture to be directed away from the test fixture. A temperature of the test fixture can be reduced to below a maximum temperature threshold, such as a cryogenic temperature threshold. A length of the elongated enclosure can be sufficient to prevent the temperature of the test fixture from impacting an operating temperature of the laser vibrometer. An acceleration event can be simulated with respect to the test fixture. The elongated enclosure can have at least one flexible portion such that a force applied proximate the first end of the elongated enclosure is not transferred to the laser vibrometer connected to the second end. The laser vibrometer can be used to measure at least one parameter difference between a test beam, emitted from the laser vibrometer, and a portion of the test beam reflected from a test region of the test fixture.

These and other illustrative embodiments described or suggested in the detailed description, drawings, and/or claims are not meant to be limiting. Other embodiments may be used, and other changes may be made, as well without departing from spirit or scope of the subject matter presented here.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. As mentioned, illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise. Various embodiments in accordance with the present disclosure will be described with reference to the drawings, in which:

FIG. 1A illustrates a first example test assembly to test a region on a test fixture, in accordance with at least one embodiment;

FIG. 1B illustrates a second example test assembly to test a region on a test object, in accordance with at least one embodiment;

FIG. 2 illustrates a block diagram including components of an example test assembly, in accordance with at least one embodiment;

FIG. 3 illustrates an example process for setting up a cryogenic shock test to be run using a test assembly, in accordance with at least one embodiment;

FIG. 4 illustrates an example process for performing cryogenic shock testing of a test fixture, in accordance with at least one embodiment;

FIG. 5 illustrates a perspective view of a test fixture positioned with respect to a test assembly, in accordance with at least one embodiment; and

FIG. 6 illustrates components of an example computing resource that can be used to control or monitor one or more aspects of a test assembly, or process data observed during testing, in accordance with at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

As used herein, a test fixture may refer to any part, component, element, object, surface, or material on which shock, vibration, or similar testing may be performed as discussed and suggested herein. This may include, for example, a support structure to be used in a launch vehicle that will undergo at least one shock event at altitude, or a navigation component in a vehicle that may be subject to significant engine (or other vibration). The test fixture may include one or more test regions where it is desired to determine or predict a response, such as a response to a shock event, rapid acceleration, or sequence of vibrations.

As used herein, a shock event may refer to any occurrence which imparts a force on an object of interest. The force will typically be of significant magnitude to trigger a response in the object. The force will often also be applied with significant speed or rapid acceleration. Such a force applied to the object may result in various accelerations, motions, vibrations, or deformations, and may sometimes result in cracks or fissures, particularly at temperatures below a threshold, where that threshold can depend in part on the material. Other types of events may be simulated as well, as may relate to vibration events. For example, approaches disclosed herein may be used advantageously for vibration testing of parts, such as lunar components that require temperatures significantly colder than, say, −320 F.

As used herein, a “controlled” environment may refer to any space, region, or volume that is at least partially contained within an enclosure or structure, such as a tube, cone, cavity, or channel. The enclosure may be at least partially sealed, in order to provide at least some restriction on moisture or particulates passing through the optical measurement path of the laser vibrometer. A flow of a dry purge gas can be supplied to reduce the dew point of the entrained gasses and prevent condensation from forming on the measurement surface of the fixture. This can help to ensure that there is an adequate optical surface for the laser vibrometer, as well as to reduces the likelihood that ice crystals will break free from the surface of the fixture during a shock, vibration, or other such event and float through the path of the laser vibrometer, causing an erroneous measurement.

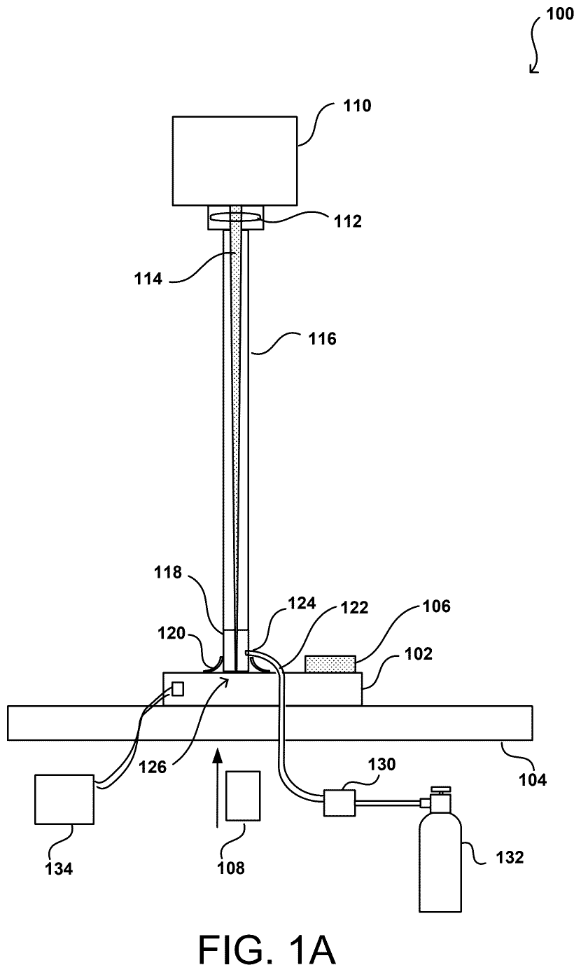

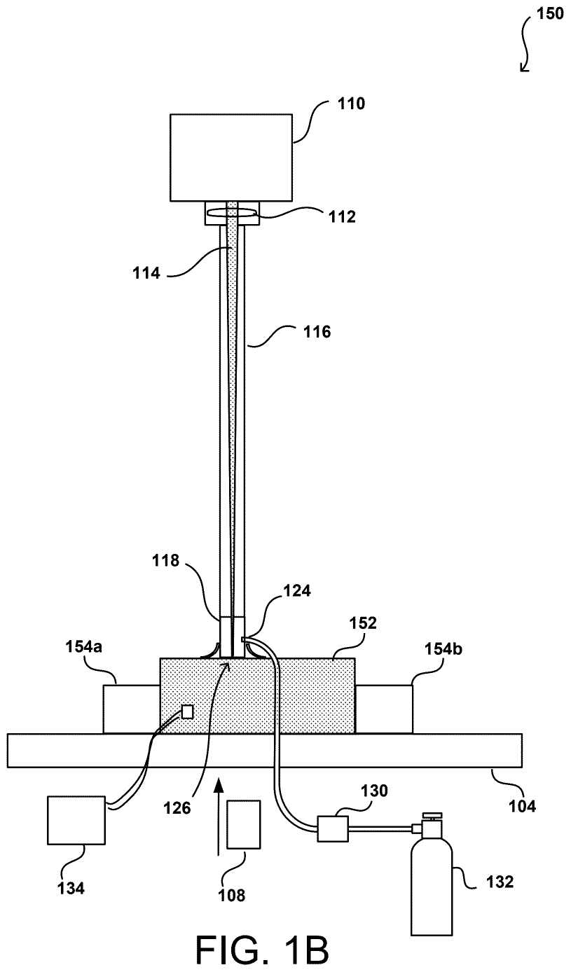

FIG. 1A illustrates aspects of an example testing assembly 100, or test supporting apparatus, according to at least one embodiment. In this example, a physical component, such as test object 106, is to undergo one or more types of testing. The test object 106 can be any appropriate part, assembly, or component for which testing can be performed using such an assembly. Without limitation, this can include shock, acceleration, or vibration testing of a test object 106, such as may be experienced during operation of a vehicle (e.g., a launch vehicle) in (or on) which that object may be located. Testing can also be performed at one or more specific temperature ranges, such as may be within a cryogenic range of temperatures.

In the configuration of the testing assembly illustrated in FIG. 1, a test object 106 is placed on a test fixture 102 of a testing apparatus, in this example a shock table 104, or other substrate, structure, or surface that is able to simulate a “shock,” acceleration, or vibration-type event. This can include, for example, the striking or rapid acceleration of the table in a specific direction, such as vertically or “up” in FIG. 1A. An event in which a sudden force is applied in a specific direction may correspond to, for example, the forced release of a stage of a multi-stage rocket or portion of a launch vehicle, among other such options. In advance of such an event, it can be important to understand how various components will respond to the event, such as to ensure that a given component can withstand an amount of force or rapid acceleration at low temperatures and will not be likely to crack or otherwise fail. This may include testing multiple at least one test region on a test fixture 102, to measure the acceleration associated with a simulated shock event, and then analyzing the test object 106 to determine whether there were any cracks, failures, or defects introduced during the simulated shock event. A test object 106 can be secured to the test fixture 102 on the shock table 104 using, for example, bolts, clamps, or other such fasteners or mechanisms that can rigidly attach the test object 106 to the test fixture 102. The nature of the testing can allow for the test region to be positioned very close to the test object 106 on the test fixture 102, to ensure that the acceleration experienced by the test object 106 is as close as possible to the acceleration measured at the test region 126. Other approaches that require an accelerometer may not allow for such proximity, as accelerometers can experience issues at low temperatures as discussed elsewhere herein. While other connection mechanisms can be used as well that may not provide for such rigid connection or attachment, such connections may absorb some of the acceleration or vibration from the test and thus not transfer the full effect of the test or simulation to the test object 106. If a physical force is to be applied manually, a relevant portion of the shock table 104 may be made of a material (e.g., aluminum or metal) that can withstand force being applied by a cannon (e.g., a steel slug of a determined weight or size projected through a nozzle at a controlled rate), rubber hammer, steel slide, pendulum system, vibration table, force beam, pyrotechnics, or other such tool or mechanism to simulate an acceleration, vibration, or shock event and cause a portion of the shock table to move in a determined direction, such as vertically in this example, although acceleration and response can be measured in any relevant direction in various embodiments. Devices such as triaxial laser vibrometers can be used in some instances to determine vibration or acceleration in multiple different directions. During testing, an acceleration measurement can be taken with respect to the test fixture 102 to which a test object 106 is connected, in order to measure the acceleration environment delivered to the test object 106 by the testing apparatus. The test fixture 102 in such an arrangement is merely an adapter that replicates the “installed condition” of the test object 106 (example bolt mounting pattern), and also provides a mechanism for mounting the test fixture 102 to the testing apparatus via a standardized grid of holes. A test fixture 102 can support multiple test objects 106 during a single shock simulation in at least one embodiment, enabling multiple test objects 106 to be tested concurrently.

Approaches disclosed herein can use an optical measurement system or device, such as may utilize a laser vibrometer 110, to measure the response of a test fixture 102 to a simulated shock event. This can be used up to very high shock levels, such as those upwards of around 5,000 g to 10,000 g in magnitude of gravitational acceleration. A laser vibrometer 110 can measure changes in the intensity (or other such aspect) of a laser beam incident on a test region of a surface, such as the test fixture 102. A change in intensity can be driven by relative phase shifts of the reference and measurement beams, where only one is sent to the test fixture surface and back. Changes in the intensity over a period of time during and immediately after a shock event (or other such event) can give information about the response of the test fixture 102 to the shock event, such as an initial movement or acceleration in a direction corresponding to the shock event, followed by one or more subsequent movements. These subsequent movements can include at least an acceleration or movement back to the original position before the shock event. There may be subsequent movements or accelerations as well, such as a decreasing sinusoidal-like motion until the component returns to a rest position. Such testing may be performed at multiple locations, as different locations (particularly those made of multiple materials or having regions of varying thickness) can react differently to a shock event. It should be understood that while shock testing is a primary example discussed herein, there may be other types of motion (or other) testing performed as well using such a testing assembly, as may relate to vibration testing or other such testing where at least a motion, force, or acceleration response is to be observed.

In this example, one type of testing that can be performed is shock testing performed at relatively low temperatures. This can include, for example, testing at cryogenic temperatures (e.g., temperatures less than −200 degrees Fahrenheit, or less than −300 degrees Fahrenheit for different cryogenic ranges) in order to simulate conditions during, for example, orbital launch or space travel. Accordingly, a cooling component 134 can be used to bring the test fixture 102 to a desired temperature. At least one temperature sensor (not illustrated) can be used to monitor a temperature of the test fixture 102, and can provide a signal back to the cooling component 134 to make adjustments in cooling as appropriate. The cooling can be applied to the test fixture 102 and/or may be applied to a portion of the shock table 104 or surrounding environment, among other such options. A cooling component 134 can use any appropriate mechanism for cooling and temperature control, as may relate to use of a refrigerant, set of cooling tubes or a thermal blanket, or a flow or spray of low temperature media. The response of the test fixture 102 to a shock event can differ over different temperature ranges, so it can be desirable to test over at least some of these ranges to understand the response of the component. The response can help to understand any changes in the flexibility or rigidity of a test object 102, for example, as well as to understand a risk of cracking or fissures at lower temperatures for certain types of shock. For specific events, such as the separation of a rocket stage during a launch event that happens at a specific range of heights above a planet surface, the testing can be performed for a specific type of shock, of a certain magnitude, over an appropriate range of temperatures for that height range.

As mentioned above, there are various tools that can be used to measure response to a shock event, but at least some of these have deficiencies or issues with accuracy or reliability, particularly at cryogenic temperatures. As an example, an accelerometer can experience zero-shift issues or outright sensor failure at cryogenic temperatures, which can result in inaccurate measurements. In this example test setup, a laser vibrometer 110 (as may include a base station and a laser sensor head) is used to test the response of a test region 126 of a surface of a test fixture 102. In this example, a lens assembly 112 can be used to focus a laser onto the surface of the test fixture 102 within the test region 126. In other embodiments, a flexible fiberoptic component or adjustable head may be used in place of a lens assembly. A visible guide laser may be used to adjust the lens assembly to provide the appropriate focus on the test region. During testing, a test beam 114 can be emitted from the laser vibrometer 110 and directed to the test region 126 of the test fixture 102. The test beam 114 can be reflected from the surface at the test region 126 and at least a portion of the test beam 114 (as may be referred to as a measurement beam) reflected back to the laser vibrometer 110. A light sensor of the laser vibrometer of the laser vibrometer can measure one or more aspects of the reflected measurement beam, such as may relate to an intensity of the beam. In at least one embodiment an interferometer-type measurement can be generated where there are slightly different frequencies of light emitted, and then the reflected intensity is measured based on how those emissions of light are interfering, among other such options. In this example, a processor in the laser vibrometer 110 can compare the measured values against the corresponding values of the test beam 114 as emitted, and can provide data on any changes or variations over a period of testing. In at least one embodiment, the laser source used by the laser vibrometer 110 is a continuous wave (CW) laser, such as a CW infrared (IR) laser, that may have one or more adjustable parameters, but those parameters should remain substantially constant (within an associated tolerance or acceptable variance) during operation. The changes in parameters, such as reflect intensity, can be analyzed (using the processor of the laser vibrometer 110 or an external computing device) to calculate or acceleration the response of the test region 126 of the test fixture 126 during the test period.

An issue can arise during such testing, however, due in part to the reduction or drop in temperature of the test fixture (and the surrounding environment). Moisture in the air near the test region 126 may lead to condensation on the surface of the test fixture 102. A key issue that has historically prevented the use of non-contacting measurements for cryogenically-conditioned shock and vibration test setups has been the formation of ice crystals and/or water droplets which are displaced during dynamic testing and risk causing erroneous measurements of the laser vibrometer by floating through the path of the emitted and/or reflected laser light. To prevent formed condensation from entering the pathway of the non-contacting measurement setup a purged container may be constructed around the optical measurement device and test fixture. As one example, any water droplets present in the test region 126 during testing can impact the accuracy of the test measurements, as the droplets can lead to scattering of the test beam 114, or other types of reflections or refractions, which can cause measurements of the test beam to be unreliable at best. Even if ignoring scattering and other such effects, the response of a water droplet on the surface of a test fixture 102 will likely have a much different response to a shock event, such that the data determined by the laser vibrometer may not be reliably determined as the response of the part. Moisture in the air in the form of small water droplets can also effect the measurements by scattering laser light passing between the laser vibrometer 110 and the test region 126.

In this example, an attempt is made to preclude water droplets or ice crystals from passing through the measurement beam between 110 and 126 during a shock event, for example, and a subsequent measurement period. This example testing assembly uses a flow of dry purge gas to attempt to remove moisture from the air near the test surface. A controlled environment is formed in this example using an elongated tube 116, or other such elongated enclosure, that is shaped and positioned to surround the test beam 114 and the test region 126 during testing. The elongated tube 116 has an elongated shape to allow for sufficient separation of the laser vibrometer 110 from the test region 1126, while keeping the internal volume relatively small in order to decrease the size of the environment in which moisture is to be controlled. The elongated tube 116 can be formed of any appropriate material, such as a plastic, polymer, glass, thin rubber, or Mylar®-type material. A Mylar®-type plastic film has been observed to provide sufficient enclosure while also being able to withstand incidental contact with liquid nitrogen (or another cooled gas or element) without cracking or otherwise being compromised. The elongated tube may be adjustable, such as may incorporate a telescoping feature to allow for length adjustment.

In this example the tube has a flexible tube portion 118 proximate the test fixture 102. In other examples, the entire tube may have a minimum flexibility, so long as alternative mitigations are in place to prohibit the induced dynamic environment from being transmitted to the vibrometer measurement system. The flexible tube portion 118 will be removably attached or connected to the test fixture 102, such as by using tape 120, an adhesive, a magnet, a clamp, or another such mechanism. During shock testing, motion of the test fixture 102 will result in movement of the tape 120 or other connector, which can then apply a resulting force on the elongated tube 116. Having a flexible tube portion 118 connected to the test fixture 102 can allow the flexible tube portion to absorb most of the impact of the shock without imparting a significant force on the bulk portion of the elongated tube 116 that is connected to the laser vibrometer 110. In other examples, a flexible portion may instead (or additionally) be connected to the laser vibrometer, to reduce an impact of any vibration or motion of the bulk tube. It has been observed that polyethylene films have produced reasonable results for this purpose. Avoiding unintended motion of the laser vibrometer 110 and elongated tube 116 can help to avoid inaccuracies in the measurements that might otherwise be encountered. The laser vibrometer 110 can also be mounted using a mounting assembly (not illustrated in the figure) that is physically separate and isolated from the shock table 104 or other shock testing equipment to further avoid any unintended motion of the laser vibrometer 110 during testing. The mounting assembly may also include one or more shock absorbing materials or components to further avoid unintended motion resulting from the shock test or other such sources. If a visible guide laser is used, it can be beneficial to use a tube material that is at least slightly transparent or transmissive in order to be able to view and focus the guide beam. If focus is instead determined through another approach, such as by maximizing beam reflection or optimizing another such beam parameter, then the tube or other enclosure material may be opaque.

The controlled environment created by the elongated tube 116 can help to prevent moisture from moving into the test region from the surrounding environment. The tape 120 (or other mechanism) used to attach the flexible tube portion 118 to the test fixture 102 can also help to create a seal between the flexible tube portion 118 and the test fixture 102, to further isolate the controlled environment. In many instances, however there will be some amount of moisture in the controlled environment that may still lead to condensation if not removed. Accordingly, the test assembly 100 in this example uses a flow of purge gas to remove moisture from the controlled environment. A source 132 of purge gas (e.g., gaseous nitrogen) can be used, such as a canister of an inert gas that will have low reactivity with other substances in the controlled environment. In this example test setup, it can be beneficial for the inert gas to be dry, such as may correspond to a dewpoint of at least −68 degrees Fahrenheit, or less than −100 degrees Fahrenheit, and to be relatively inexpensive as a constant purge flow can utilize a significant amount of the selected gas. The purge gas can be directed through a pressure regulator 130 (or flow control valve or other such mechanism) that can control an amount of purge gas that is introduced into, or maintained within, the controlled environment. The flow of purge gas can be directed through flexible tubing 122 into an inlet 124 of the elongated tube and/or flexible tube portion 118. The location of the inlet can be relatively close to the test region 126 so that the flow (or pressure) will cause any other air, gas, or particles to be displaced from the controlled volume through the elongated tube 116. The internal pressure and/or flow rate (e.g., a flow rate of around 500-2000 cubic centimeters per minute (SCCM), or enough to increase the pressure in the enclosure by at least 1/10 PSI) should be enough to create positive pressure within the tube, but not so excessive that the tube may become disconnected from the surface of the test fixture. To further ensure the test object surface within the controlled volume remains clear of condensation, the dry purge gas may be angled towards the object surface providing additional disruption and removal of any formed condensation via kinematic effects.

The end of the elongated tube 116 away from the test surface may not be tightly sealed, or may include some type of outlet, to allow some of the dry inert gas inside the controlled environment to be pushed, or otherwise flow, out of the controlled environment. An outlet port may not be required, as such a tube will generally not be completely airtight, and it may be sufficient to maintain a positive pressure within the controlled environment to help prevent incoming moisture. A flow of gas from (or region of higher pressure) near the test region in a direction away from the test region can help to expel moisture (and other undesired contaminants or particulates) from the controlled environment. The purge gas used may also be a heavier gas, such as argon, that will tend to stay closer to the test fixture 102 due to gravity, further displacing gasses with high dewpoints from the area immediately surrounding the test region 126. By moving moisture away from the cold test region 126, the amount of condensation on the test surface during testing can be significantly reduced.

In this example, the purge gas may be allowed to flow into the elongated tube 116 for a period of time before testing occurs. This pre-testing flow can be used to remove moisture (and other particulates or contaminants) from the controlled environment before testing occurs, to ensure a relatively moisture-free environment. This may occur for a period of time before the temperature of the test fixture 102 is decreased, or drops below a given temperature, to avoid formation of condensation on the test surface. The amount of time used to purge the environment of moisture can vary based on several factors, such as the temperature to be used for testing, the type of material of the test region, the amount of humidity in the ambient air at the test facility, and other such factors.

FIG. 1B illustrates another example test assembly 150 that can be used in accordance with various embodiments. Reference numbers may be carried over between figures for simplicity of explanation, but such usage should not be interpreted as a limitation on the scope of the various embodiments unless otherwise specifically stated. In this example, the test region is on a test object 152 itself, rather than on a test fixture. The test may then measure the actual response of the test object 152 at one or more places. The elongated tube 116 may be attached directly to the test object 152 to create a test region 126 on the test objects. One or more support blocks 154(a), 154(b) may be added to the shock table 104 to modify the acceleration response generated by the projectile 108 or other acceleration or shock-inducing apparatus, such as where blocks of a certain size, weight, or material may provide for some amount of damping or other effect that may be representative of an environment in which a test object may be implemented. If the test object has regions of different material, thickness, or other such aspects, it may be advantageous to test the response for at least some of those regions to better understand the effect of a shock (or similar) event on the test object 152 as a whole. In such an example, the elongated tube 116 can be comprised of a compliant thin film sheet or other material to preclude water droplets or ice crystals from passing through the measurement beam during the shock event and subsequent measurement interval (as may last approximately 1 second in at least one embodiment).

Such a test assembly can support shock testing of various components over a range of temperatures, including cryogenic temperatures. This can include determining response data over the shock response spectrum (SRS). Such an assembly has advantages over other potential measurement devices or sensors, as may use off-the-shelf accelerometers, as these devices are unable to function accurately in cold environments (e.g., −320 F or less) and under shock conditions, such as those associated with a high-powered rocket engine. As an example, existing accelerometers experience “zero-shifting” of data due to the extreme conditions, which can introduce errors in the SRS calculation. Instead, a doppler laser vibrometer can be directed at a component to be tested. A test assembly as described can help to remove moisture from the test environment, which allows the vibrometer to be able to make measurements with respect to clear, flat surface of a test fixture that is able to reflect the laser light without introducing scattering or other undesired effects that might otherwise impact the measurements. In cryogenic conditions, unremoved moisture can condense and/or freeze on a test surface, which could then obscure the laser and introduce errors in the vibrometer measurements.

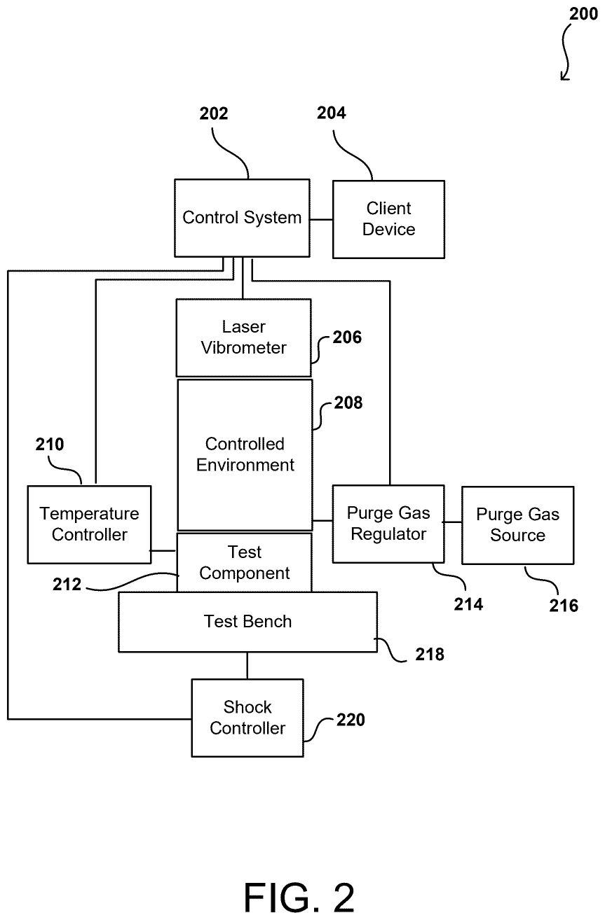

FIG. 2 illustrates a block diagram showing components of an example testing assembly 200 according to at least one embodiment. Although this example system illustrates multiple components under automated control of a control system 202, it should be understood that at least some of these components can be controlled manually, or through a combination of automated and manual operation. In this example, a user (e.g., a test engineer) is able to use a client device 204 to interact with a control system 202, such as to be able to provide instructions to the control system to initiate a test using specific parameters, and to receive results of the testing, from the control system 202 or from specific systems or devices used as part of the testing assembly, among other such options.

This example test assembly 200 includes a test bench 218 on which a test component 212 (or other object to be tested) can be placed, such as a test object that may be connected to a text fixture as discussed herein. There may be other types of supports used as well, to which a part can be connected, placed into, or otherwise arranged. In this example the test bench 218 is connected to a shock controller 220 that can control a direction, amount, duration, timing, force/velocity, and other such aspects of a shock event. In other examples, a shock may be applied manually, or by using another such approach. If a shock controller 220 is used, the shock controller 220 may be in communication with the control system 202 to ensure proper coordination of the shock with other aspects of the testing. If manual shock is applied, this may involve a person causing a portion of the test bench 218, or element connected to the test bench, to be struck, such as with a blunt instrument. In other examples, a shock application device might be used that is manually triggered by a human, among other such options.

This example test assembly 200 also includes a temperature controller 210. A temperature controller 210 can include, or work with, a temperature regulation or modification mechanism that can be used to control a temperature of the test component 212 during testing. This can include, for example, using a refrigerant or cooling gas to cause the test fixture to be cooled to a target temperature, and maintaining the test component 212 at that temperature during testing. In this example, the temperature controller 210 works with the control system 202 to manage the temperature according to an overall test plan. In other embodiments, a human might enter a temperature setting on the temperature controller 210, or cause a temperature controller to be activated and then manually monitor and adjust the temperature settings as needed.

This example test assembly 200 includes a laser vibrometer 206 that is positioned relative to the test component 212 to be able to perform vibration and/or shock response testing. The laser vibrometer 206 can include a test beam that is able to be focused on the test fixture using an appropriate lens assembly, and then the same laser beam (or a separate test beam) can be directed to the test component 212 during testing. A light sensor of the laser vibrometer can then make measurements on the test beam as reflected from the test fixture at the reduced temperature, and the laser vibrometer can make measurements for changes between the emitted and reflected beam, as may relate to changes in amplitude, frequency, phase, polarization, or intensity, among other such metrics. The results can be provided to the control system 202 for use in determining further testing, as well as to the client device 204 for analysis by a user.

As mentioned, an controlled environment 208 can be used to help keep the presence of moisture and contamination between the laser vibrometer 206 and the test component 212 to a minimum. This can help to ensure that test measurements are not negatively impacted by condensation or freezing of the test surface, scattering of the laser light due to particulates, or other such undesired occurrences. The controlled environment 208 can be provided using an elongated structure, such as a tube, channel, or cone that allows the test beam to pass through a central opening or cavity of the structure. The elongated structure can be at least partially flexible, or have a flexible portion, that can prevent motion of the test bench 218 and/or test component 212 from being transferred to the laser vibrometer 206.

A purge gas can be used to displace ambient air with a higher dewpoint and thus preclude the formation of ice crystals on the surface of the test component within the controlled environment 208 via condensation. In this example, a purge gas source 216 can correspond to a canister of inert gas or other such source. A purge gas regulator 214 can be used to control the flow, pressure, or other aspect of the purge gas introduced into the controlled environment 208, whether under manual control or control of the control system 202, among other such options. In one experiment, the pressure regulator performed a step down to a range between about 5 PSI and 7 PSI. The purge gas can be introduced into the controlled environment 208 proximate the test fixture, and can be caused to flow away from the test fixture to the other end of the elongated structure, which can help to move moisture or particulates away from the test component 212 and out of the controlled environment. As mentioned, one or more openings, outlets, or unsealed connections can be used to allow the moisture and particulates to pass from the controlled environment. The purge gas may be supplied for some amount of time before temperature reduction and testing, to ensure relatively contaminant and moisture free testing conditions.

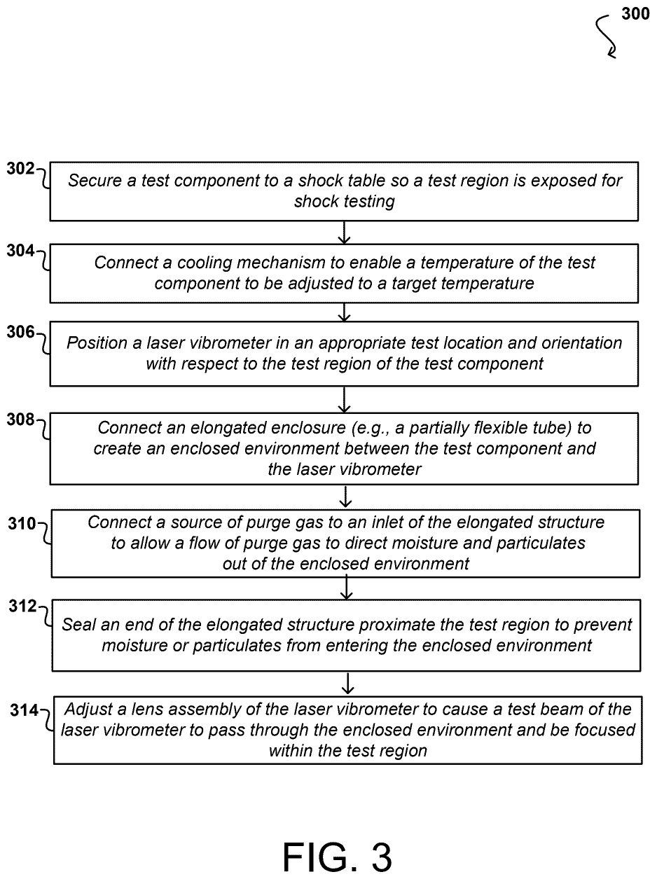

FIG. 3 illustrates an example process 300 for setting up a temperature-controlled shock test according to at least one embodiment. It should be understood that for this and other processes presented herein that there may be additional, fewer, or alternative operations performed in similar or alternative orders, or at least partially in parallel, within the scope of the various embodiments unless otherwise specifically stated. Further, although this process is described with respect to shock testing and cryogenic temperatures, it should be understood that advantages of various approaches can be obtained for other types of testing over other temperature ranges as well. In this example, a test fixture is secured 302 to a shock table, or other surface or support structure that can be used to simulate a shock-type event. The test fixture can be arranged and/or oriented such that at least one test region is exposed for shock testing, in a location appropriate for the type of testing to be used. In an example where a laser vibrometer is to be positioned vertically above the test region, the test fixture can be arranged such that a local surface at the test region is substantially horizontal, such that the direction of the laser from the laser vibrometer will be orthogonal to the surface and can be at least partially reflected back to the laser vibrometer.

To be able to have the test fixture at a reduced temperature during the test, a cooling mechanism can be connected 304, or otherwise provided as appropriate. For sprays or flows of gas, physical connection to the test fixture or shock table may not be required. A cooling mechanism as discussed herein can allow for a temperature of a test fixture to be reduced (or otherwise modified) to a target temperature, or a temperature within a target temperature range. This can include, for example, using a refrigerant or coolant flow to drop the temperature of a test fixture to a cryogenic temperature. To perform the desired testing for at least one test region of the test fixture, a laser vibrometer (or other optical response device) can be positioned 306 in an appropriate test location and orientation with respect to the test region of the test fixture. As mentioned, this may include positioning the vibrometer a given distance from the surface at the test region, in a direction that is along a normal to the surface at a point of focus within the test region.

To reduce a presence of moisture or condensation on the test fixture, an elongated enclosure can be connected 308 to the test fixture around the test region. The elongated enclosure can take the form of a tube, cone, pipe, channel, or other such elongated structure with an internal opening that allows a laser beam from the vibrometer to pass to the test region and be reflected back through a controlled environment. The structure can be connected to the test part using tape, adhesive, epoxy, or another such mechanism, as discussed in more detail elsewhere herein. To remove moisture (and particulates, etc.) from the controlled environment, a source of dry inert purge gas can be connected 310 to an inlet of the elongated structure, proximate the test region. A flow of purge gas in the controlled environment can cause moisture to be directed away from the test region and out of the controlled environment. The purge gas can be applied before testing to remove moisture, and during testing to help to prevent moisture from entering the enclosed test environment. To help better enclose the environment, at least an end of the elongated structure proximate the test region can be sealed 312, which can help to prevent moisture or particulates from passing through the measurement beam of the vibrometer. The sealing can be performed using the tape, epoxy, or other mechanism used to connect the elongated enclosure to the test fixture, or another appropriate sealing element or approach. A lens assembly of the laser vibrometer can be adjusted 314 to cause a test beam of the laser vibrometer to pass through the controlled environment and be focused within the test region. Other adjustments or settings can be made as needed to prepare the test assembly to perform cryogenic shock testing, or other such testing.

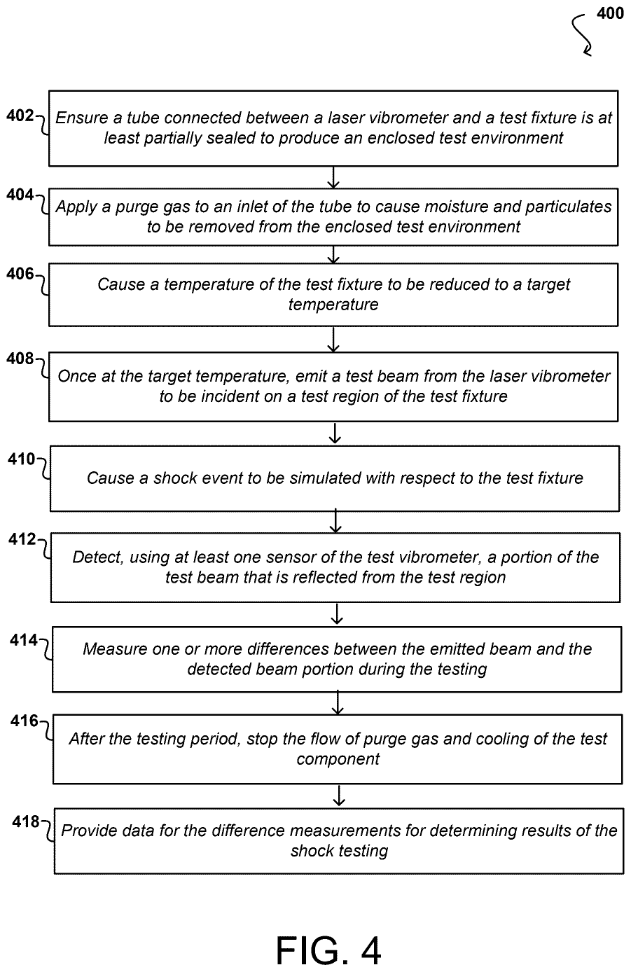

FIG. 4 illustrates an example process 400 to performing cryogenic shock testing according to at least one embodiment. This process can be performed using a test assembly configured as discussed with respect to FIG. 3. In this example, it can be ensured 402 that a tube (or other enclosure) is connected between a laser vibrometer and a test fixture, and that the tube is at least partially sealed to produce an enclosed test environment. There may be an inlet for a source of purge gas, and at least one opening, gap, or outlet to allow gas to flow from the environment, but the environment can otherwise be primarily sealed. Before starting the test, a flow of purge gas can be applied 404 to an inlet of the tube to cause moisture and particulates to be removed from the enclosed test environment before testing is performed. The removal of moisture can help to prevent condensation forming on the test fixture, among other such advantages. A temperature of the test fixture can be caused 406 to be reduced to a target temperature, or a temperature within a target range. The decrease in temperature might occur after some period of time of purge gas flow, such that the amount of moisture near the test region is reduced. The temperature can be caused to be dropped using a cooling mechanism such as a refrigerant or coolant flow, among other such options.

Once the test part is determined to be at the target temperature, such as by using an appropriate temperature sensor or determination mechanism, a test beam can be emitted 408 from the laser vibrometer to be incident on a test region of the test fixture. At least a portion of the test beam can be reflected from the surface and detected by the laser vibrometer. While the vibrometer is measuring changes in motion of the test region, a shock event can be caused 410 to be simulated with respect to the test fixture. As discussed, the shock can be simulated in a number of ways, such as through a manual application of force to a shock table or a fast motion initiated by an automated test assembly, among other such options. At least one sensor of the laser vibrometer can be used 412 to detect a portion of the test beam that is reflected from the test region during, and around, a period of the shock event. One or more differences between the emitted beam and the detected beam can be determined 414 during the testing, as may relate to changes in amplitude, frequency, intensity, phase, and/or polarization of the beam. After the testing period has completed, the flow of purge gas can be stopped 416, we as well as the cooling of the test fixture, which may be allowed to return to ambient (or other) temperature. Data determined using the difference measurements can be provided 418 for determining results of the shock testing. This may include, for example, determining a pattern of response of the test region to the shock event, as may relate to an extent and rate of movement, as well as a pattern of settling or otherwise returning from any changes due in part to the shock event. Other results may be able to be determined as well, as may relate to an amount of compression or distortion, among other such options.

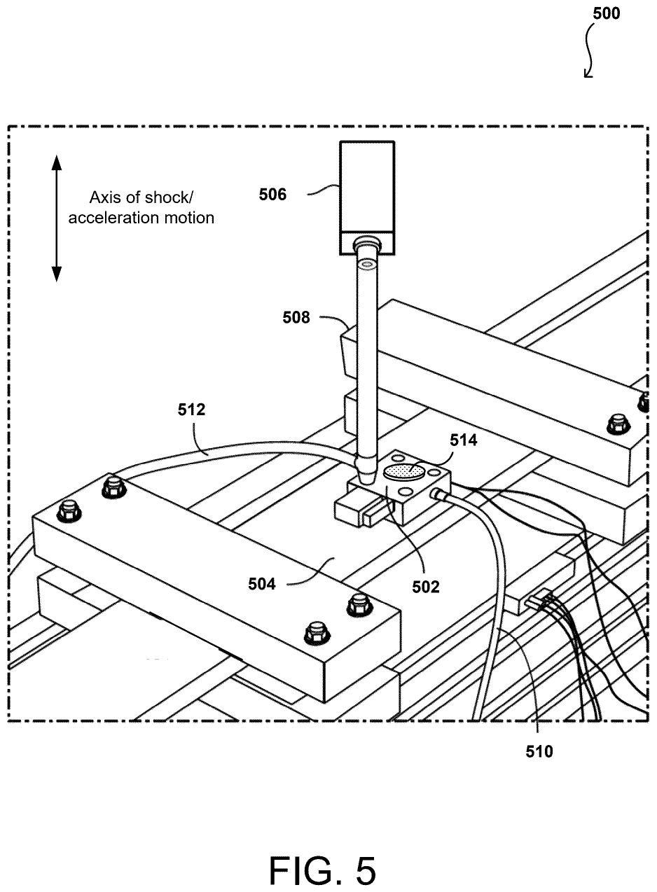

FIG. 5 illustrates a perspective view 500 of an example test assembly during cryogenic shock testing. As illustrated, a test object 514 is placed on a test fixture 502 of a shock table 504. A laser vibrometer 506 (e.g., a Polytec OFV5000 extra) can be positioned at a given distance and orientation from the test region of the test fixture 502 (or test object 514 in some embodiments), such as between six inches and two feet away along a normal to the surface within the test region, as may correspond to an approximate focal length range of the laser vibrometer and/or lens assembly. The vibrometer can produce a continuous wave laser beam over an appropriate wavelength, such as may correspond to the IR spectrum, and may also include a visible focus beam as discussed above. An aluminum or similar support structure can be used to hold the vibrometer in place, where the support structure is not connected to the shock table 504 to be isolated from forces due to a simulated shock event. A test beam from a laser vibrometer 506 can pass through an elongated tube 508 and focused within a test region on the test fixture 502, with a portion of the beam being reflected back to the laser vibrometer. A tube as illustrated can be of a length sufficient to provide a controlled environment between the laser vibrometer 506 and the test fixture 502, such as a length between six inches and twenty-four inches as mentioned. The tube may have a relatively small diameter, such as may be on the order of about one inch to three inches, which would allow for the laser beam to pass unobstructed (i.e., with a clean line of sight) and provide sufficient volume for the enclosed test environment, while not being so large as to require an unnecessary amount of purge gas to be used, which as mentioned elsewhere can be expensive based in part upon the type of gas used. Smaller tubes also require less tube material, which can be more cost effective and easier to secure in place. A tube may be cylindrical or non-cylindrical in shape, such as may have at least a conical portion near the test region if the available footprint on the test fixture is small. To reduce condensation on the surface in the test region, a flow of purge gas 512 can be directed into the elongated tube 508 to cause moisture to be directed away from the test region and be expelled from the test environment. A source of coolant 510 is also supplied to cause a temperature of the test fixture to be reduced to a target temperature for testing. The shock table can include (or be used with) one or more shock inducing elements, such as a pneumatically driven metal projectile block that can impact the shock table 504 where the test fixture 502 is mounted. Other shock inducement tools can be used as well, which may be able to more accurately simulate a shock event of a specific magnitude and direction. Components of the test assembly can be selected and configured as discussed elsewhere herein. Such a test assembly may be adjusted to improve results for different types of testing, such as low frequency, high displacement shock events versus higher frequency or lower displacement shock events, as the laser vibrometer may be able to measure one type of change, such as a high amplitude acceleration or a high displacement, but not both types together in a single test. Such an assembly can be used for any cryogenic temperature (or higher temperature), provided the test surface can be maintained significantly free from first, and the laser head of the vibrometer is far enough away to remain at (or near) ambient temperature so no condensation or frost forms on the lens of the laser vibrometer. Such an assembly can be used for vibration testing as well, such as to simulate operation of an engine and measure the response of a test fixture during the operation.

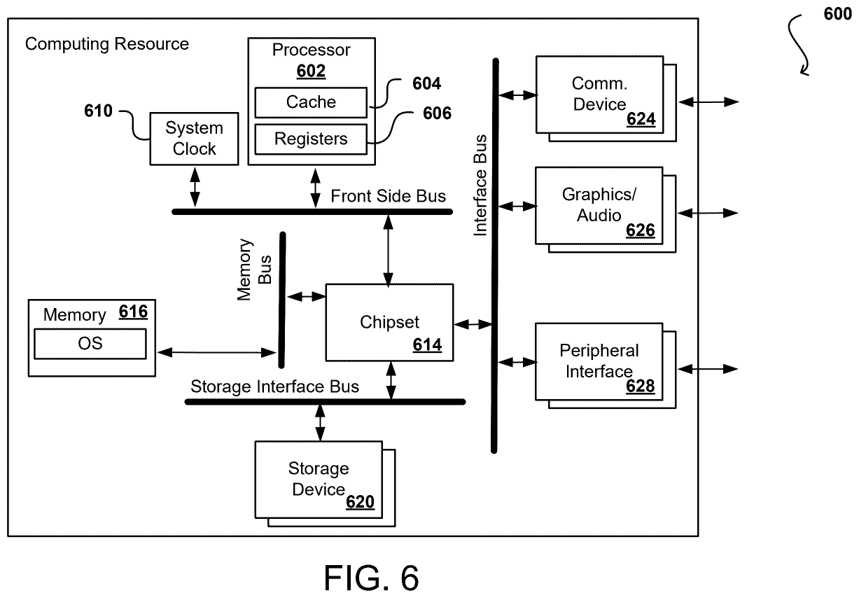

Although excluded from FIG. 5 and FIG. 6 primarily for clarity and ease of understanding, in at least one embodiment there will be a structural decoupling between the laser vibrometer and the test article. This decoupling may be accomplished using some compliant media, such as a polyethylene sheet. There may also be overarching structure provided to assist with the decoupling, such that the vibrometer is not balanced on top of the semi-rigid tube.

As mentioned, certain test assemblies or systems may use one or more computing devices in the performance of one or more tests, such as may control or monitor aspects of the test, or collect and analyze data from the tests, among other such options. Computing resources, such as servers, routers, smartphones, or personal computers, will generally include at least a set of standard components configured for general purpose operation, although various proprietary components and configurations can be used as well within the scope of the various embodiments. As mentioned, this can include client devices for transmitting and receiving network communications, or servers for performing tasks such as network analysis and rerouting, among other such options. FIG. 6 illustrates components of an example computing resource 600 that can be utilized in accordance with various embodiments. It should be understood that there can be many such compute resources and many such components provided in various arrangements, such as in a local network or across the Internet or “cloud,” to provide compute resource capacity as discussed elsewhere herein. The computing resource 600 (e.g., a desktop or network server) will have one or more processors 602, such as central processing units (CPUs), graphics processing units (GPUs), and the like, that are electronically and/or communicatively coupled with various components using various buses, traces, and other such mechanisms. A processor 602 can include memory registers 606 and cache memory 604 for holding instructions, data, and the like. In this example, a chipset 614, which can include a northbridge and southbridge in some embodiments, can work with the various system buses to connect the processor 602 to components such as system memory 616, in the form or physical RAM or ROM, which can include the code for the operating system as well as various other instructions and data utilized for operation of the computing device. The computing device can also contain, or communicate with, one or more storage devices 620, such as hard drives, flash drives, optical storage, and the like, for persisting data and instructions similar, or in addition to, those stored in the processor and memory. The computing resource can also include a system clock 610 that can be referenced by various components. The processor 602 can communicate with various other components via the chipset 614 and an interface bus (or graphics bus, etc.), where those components can include communications devices 624 such as cellular modems or network cards, media components 626, such as graphics cards and audio components, and peripheral interfaces 628 for connecting peripheral devices, such as printers, keyboards, and the like. At least one cooling fan 632 or other such temperature regulating or reduction component can also be included as well, which can be driven by the processor or triggered by various other sensors or components on, or remote from, the device. Various other or alternative components and configurations can be utilized as well as known in the art for computing devices.

At least one processor 602 can obtain data from system memory 616, such as a dynamic random access memory (DRAM) module, via a coherency fabric in some embodiments. It should be understood that various architectures can be utilized for such a computing device, which can include varying selections, numbers, and arguments of buses and bridges within the scope of the various embodiments. The data in memory can be managed and accessed by a memory controller, such as a DDR controller, through the coherency fabric. The data can be temporarily stored in a processor cache 604 in at least some embodiments. The computing device 600 can also support multiple I/O devices using a set of I/O controllers connected via an I/O bus. There can be I/O controllers to support respective types of I/O devices, such as a universal serial bus (USB) device, data storage (e.g., flash or disk storage), a network card, a peripheral component interconnect express (PCIe) card or interface 628, a communication device 624, a graphics or audio card 626, and a direct memory access (DMA) card, among other such options. In some embodiments, components such as the processor, controllers, and caches can be configured on a single card, board, or chip (i.e., a system-on-chip implementation), while in other embodiments at least some of the components can be located in different locations, etc.

An operating system (OS) running on the processor 602 can help to manage the various devices that can be utilized to provide input to be processed. This can include, for example, utilizing relevant device drivers to enable interaction with various I/O devices, where those devices can relate to data storage, device communications, user interfaces, and the like. The various I/O devices will typically connect via various device ports and communicate with the processor and other device components over one or more buses. There can be specific types of buses that provide for communications according to specific protocols, as can include peripheral component interconnect) PCI or small computer system interface (SCSI) communications, among other such options. Communications can occur using registers associated with the respective ports, including registers such as data-in and data-out registers. Communications can also occur using memory-mapped I/O, where a portion of the address space of a processor is mapped to a specific device, and data is written directly to, and from, that portion of the address space.

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Terms such as “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

What is claimed is:

1. A cryogenic shock testing apparatus, comprising:
a shock table to secure a test object to a test fixture and to allow a shock event to be simulated with respect to the test object;
a temperature controller to reduce a temperature of the test object to a cryogenic temperature;
a laser vibrometer positioned to focus a test beam on a test region, and to detect a portion of the test beam reflected from the test region;
a flexible tube connectable to the test fixture to create a controlled environment between the laser vibrometer and the test fixture; and
a source of a purge gas able to provide a controlled flow of the purge gas through an inlet in the flexible tube proximate the test region, the flow of purge gas being primarily directed away from the test region to remove moisture from the controlled environment before shock testing and resist moisture from entering the test region during the shock testing,
wherein the shock event is able to be simulated via the shock table while the test object is at the cryogenic temperature, and wherein the laser vibrometer is able to detect a portion of the test beam transmitted through the controlled environment and reflected from the test region, differences between one or more parameters of the emitted test beam and the reflected portion of the test beam being indicative of a response of the test region to the simulated shock event.

2. The cryogenic shock testing apparatus of claim 1, further comprising:
a flow regulator for regulating a flow rate of the purge gas, the flow rate sufficient to reduce a probability of condensation or frost forming in the test region before, or during a period of, the simulated shock event.

3. The cryogenic shock testing apparatus of claim 1, wherein the flexible tube is sufficiently flexible to avoid imparting force on the laser vibrometer resulting from the simulated shock event.

4. The cryogenic shock testing apparatus of claim 1, wherein the flow of purge gas is directed at least partially toward the test region to remove condensation or ice forming in the test region.

5. The cryogenic shock testing apparatus of claim 1, wherein the flexible tube has a length proportional to a focal length of the laser vibrometer, and a diameter sufficient to allow for passage of the test beam and the flow of purge gas.

6. The cryogenic shock testing apparatus of claim 1, wherein the laser vibrometer is positioned along a normal orthogonal to the surface of the text fixture at a point of focus within the test region.

7. The cryogenic shock testing apparatus of claim 1, wherein the controlled environment includes one or more gaps, proximate the laser vibrometer, allowing for escape of moisture and at least some amount of purge gas.

8. The cryogenic shock testing apparatus of claim 1, wherein the purge gas is an inert gas introduced into the controlled environment for at least a specified amount of time before the simulated shock event to remove moisture and particulates present in the controlled environment.

9. The cryogenic shock testing apparatus of claim 1, wherein the one or more parameters includes at least an intensity.

10. A test environment, comprising:
an elongated enclosure having at least one flexible portion, the flexible portion preventing force applied proximate a first end of the elongated enclosure from triggering movement at a second end of the elongated enclosure to be coupled to an optical measurement device;
at least one connector to allow the first end of the elongated enclosure to be coupled to a test fixture, the at least one connector further providing at least a partial seal for the elongated enclosure proximate the test fixture; and
an inlet to allow a flow of purge gas to be directed into the elongated enclosure, proximate the first end to direct moisture away from the test fixture,
wherein the elongated enclosure is formed of a material configured to withstand a drop in temperature of the test fixture, and wherein a length of the elongated enclosure is sufficient to prevent the reductions in temperature from impacting an operating temperature of the optical measurement device.

11. The test environment of claim 10, wherein the elongated enclosure is cylindrical allowing for light to pass between the optical measurement device and the test fixture, and wherein at least the flexible portion is formed from a flexible polymer film.

12. The test environment of claim 10, further comprising:
a support table to support the test fixture and to allow for application of a force to be applied to the test fixture.

13. The test environment of claim 10, wherein the elongated enclosure is positioned with a primary axis orthogonal to the test fixture over a test region, such that light emitted by the optical measurement device is able to be at least partially reflected by the test fixture back to the optical measurement device.

14. The test environment of claim 10, further comprising:
a flow regulator to control the flow of purge gas into the elongated enclosure by an amount that is sufficient to remove moisture from an interior cavity but insufficient to impact an ability of the at least one connector to retain the elongated enclosure.

15. The test environment of claim 10, further comprising:
a temperature controller to reduce a temperature of the test fixture before a period of testing, and maintain the temperature of the test fixture during the period of testing.

16. A method, comprising:
connecting a first end of an elongated enclosure to a test fixture and a second end to a laser vibrometer;
directing a flow of purge gas into the elongated enclosure, proximate the test fixture, to cause moisture to be directed away from the test fixture;
lowering a temperature of a test object connected to the test fixture, a length of the elongated enclosure sufficient to prevent the temperature from impacting an operating temperature of the laser vibrometer;
simulating an acceleration event with respect to the test fixture, the elongated enclosure having at least one flexible portion such that a resulting force applied to the first end of the elongated enclosure is not transferred to the laser vibrometer connected to the second end; and
measuring, using the laser vibrometer, at least one parameter difference between a test beam, emitted from the laser vibrometer, and a portion of the test beam reflected from a test region of the test fixture.

17. The method of claim 16, further comprising:
continuing to direct the flow of purge gas into the elongated enclosure for a period of time after simulating the acceleration event to prevent moisture from entering the elongated enclosure during the measuring.

18. The method of claim 16, further comprising:
directing the flow of purge gas at least partially toward the test fixture to remove any condensation or ice forming on the test fixture.

19. The method of claim 16, further comprising:
at least partially sealing the first end of the elongated enclosure, proximate the test fixture, to prevent moisture from being drawn into the elongated enclosure by the flow of purge gas.

20. The method of claim 16, further comprising:
using a flow regulator to control the flow of purge gas into the elongated enclosure to an amount that is sufficient to remove moisture from an interior cavity but insufficient to impact an ability of at least one connector to retain the elongated enclosure connected to the test fixture.
